(19) United States
(12) Patent Application Publication
(10) Pub. No.: US 2020/0407830 A1
(43) Pub. Date: Dec. 31, 2020

(54) ARTICLES WITH NITROGEN ALLOY PROTECTIVE LAYER AND METHODS OF MAKING SAME

(71) Applicant: SOMNIO GLOBAL HOLDINGS, LLC, Novi, MI (US)

(72) Inventors: Pravansu S. MOHANTY, Canton, MI (US); Ramcharan VISVESWARAN, Novi, MI (US); Vikram VARADARAAJAN, Novi, MI (US)

(73) Assignee: SOMNIO GLOBAL HOLDINGS, LLC, Novi, MI (US)

(21) Appl. No.: 16/976,155

(22) PCT Filed: Feb. 27, 2019
(86) PCT No.: PCT/US2019/019717

§ 371 Date: Aug. 27, 2020

Related U.S. Application Data
(60) Provisional application No. 62/635,744, filed on Feb. 27, 2018.

(51) Int. Cl. C22C 38/00; C22C 38/04; C22C 38/08; B32B 7/08; B32B 15/01

(52) U.S. Cl. CPC C22C 38/001; C22C 38/04; B23K 20/12; B32B 7/08; B32B 15/012; C22C 38/08

(57) ABSTRACT

Provided are materials that include one or more metals in solid solution with a level of nitrogen that is at a concentration higher than the a solubility limit of nitrogen in the alloy in a liquid state at atmospheric pressure. The materials may be utilized as a protective layer on a substrate, such as an Al containing substrate. Also provided are methods of forming the solid solution materials and articles employing them on a surface of a substrate.

### CROSS REFERENCE TO RELATED APPLICATIONS

This application depends from and claims priority to U.S. Provisional Application No. 62/635,744 filed Feb. 27, 2018, the entire contents of which are incorporated herein by reference.

### TECHNICAL FIELD

This disclosure relates to methods and materials for fabricating articles with nitrogen containing wear/corrosion resistant layer, and more specifically, with a tough iron alloy layer having high dissolved nitrogen content.

### BACKGROUND

Providing surface protection to articles against wear and corrosion by nitrogen containing case or layers is a common industrial practice. Two fundamental approaches exist; (a) diffusing nitrogen atoms/ions through the surface of a solid metal/alloy articles at an elevated temperature which is generally known as nitriding, or (b) depositing a nitrogen compounds such as CrN, VN, TiN etc., or a combination thereof, on the surface.

Several variants of nitriding processes exist such as gas nitriding, plasma nitriding, packed bed nitriding and salt bath nitriding. Sometimes, nitrogen and carbon sources are used together, especially in iron alloys, which is known as nitrocarburizing. Typically, a nitrided layer comprises of a compound layer followed by a diffusion zone, although in alloys that have strong tendency to form nitrides (e.g., Cr, Al, Ti), the diffusion zone is generally subdued. U.S. Pat. No. 7,160,635 discloses a monolithically grown nitride layer containing Ti, Al, Cr and Y on titanium alloys. As shown in FIG. 1a of this disclosure, generally, a nitrided steel has a compound zone made of ε and/or γ′ phase followed by a diffusion zone. The nitrogen concentration as shown schematically, falls off towards the core of the article.

The diffusion process during nitriding is dependent on the temperature and the solubility of nitrogen in the metal/alloy of the article. According to iron-nitrogen phase diagram for example, the expected phases are the solid solutions α-Fe[N] (nitrogen ferrite) and γ-Fe[N] (nitrogen austenite) and the nitrides γ′-Fe₄N and ε-Fe₂N. The solubility of nitrogen in iron at around 450° C. (840° F.) is about 5.9 wt. %. Beyond this, the phase formation tends to be predominantly epsilon (E) phase. This is strongly influenced by the carbon content of the steel; the greater the carbon content, the more potential for the c phase to form. As the temperature is further increased, gamma prime (γ′) phase tends to form.

Nitriding of steel is usually carried out between 500° C. and 600° C. The compound layer is typically in the order of 10 micrometers (μm) and the diffusion zone is typically in excess of 100 μm. In the case of pure iron or plain carbon steel, after nitriding the nitrogen dissolved in the diffusion zone precipitates as iron nitrides upon cooling. In the case of steel containing alloying elements with affinity for nitrogen, such as aluminum, vanadium, titanium and chromium, corresponding nitrides (Cr₂N, TiN, VN) may precipitate. The formation of Cr₂N in stainless steel is known to reduce its toughness and corrosion resistance. Further, the nitriding process cycle is generally long, in the order of 24 hours for iron alloys to achieve a nitrided layer (including compound and diffusion zone) in the order of 200 μm.

Deposition of nitrides, on the other hand, such as TiN, CrN and VN are commonly done by physical vapor deposition (PVD), (such as sputter deposition, cathodic arc deposition or electron beam heating) and chemical vapor deposition (CVD). U.S. Pat. No. 6,623,846 discloses articles with layers of sputter coated nitrided nichrome, while U.S. Pat. No. 7,294,077 discloses a continuously variable transmission (CVT) belt with PVD coated CrN. As shown schematically in FIG. 1b of this disclosure, the average nitrogen concentration stays almost constant across the coating layer and then suddenly falls at the interface of the coating and the article. Nitrides such as TiN, CrN etc., are extremely hard and brittle. While TiN, CrN coatings provide good wear and corrosion resistance, thick coatings tend to flake off, making them much less durable than thin coatings. Often, interfacial sublayers are added to manage the sudden change in the properties. For example, U.S. Pat. No. 8,920,881 discloses methodologies whereby the wear protection coating encompasses at least one relatively soft layer and at least one relatively hard layer. US Patent Application Publication No: 2014/0096736A1 discloses a piston ring with an intermediate layer having different thermal expansion coefficient than the base and the coating.

While nitriding can improve wear and corrosion resistance, it takes a long time to form a layer with appreciable thickness, and further the precipitation of nitrides especially in stainless steels diminishes the corrosion resistance and toughness. Nitride coatings on the other hand suffer from their brittleness and require intermediate layers to manage thermal and mechanical stresses especially when the thickness grows beyond a few micrometers. Yet further, sputter deposition techniques are too slow to make coatings beyond a few micrometers thickness. Providing a means to apply protective layer(s) or case having high level of dissolved nitrogen without compound layer or damaging brittle precipitate formation would benefit many industrial applications where a combination of high toughness, wear and corrosion properties are desirable.

### SUMMARY

Provided are methods for the production of articles covered with nitrogen containing tough and wear/corrosion resistant layer(s), in particular nitrogen containing alloys and articles employing such nitrogen containing tough and wear/corrosion resistant layer(s) that include such alloys.

Accordingly, an alloy layer on a metal substrate is provided, the layer contacting and overlying at least a portion of the substrate surface; the said layer comprising a mechanically tough alloy having dissolved nitrogen and optionally having a substantially homogeneous composition, in weight percent, of from 0.1 to 2.0% nitrogen. Further, the overlying layer may optionally include a single phase nitrogen alloy. Thus, an article is provided comprising a metal substrate having a substrate composition and a substrate interface, the interface having thereon a protective nitrogen containing alloy layer. Optionally, the overlying layer of this article is an iron containing alloy.

Further, an object of the present disclosure is to provide methodologies to prepare solid precursor materials having the desired dissolved nitrogen that is deposed to form the protective alloy layer on the substrate surface. Methodologies as provided herein include exposing a liquid alloy having alloying elements that promote dissolution of nitrogen to a high partial pressure nitrogen atmosphere to induce high dissolved nitrogen, and then solidifying the alloy in a manner such that the dissolved nitrogen in the liquid alloy is substantially captured in the solid precursor material. The methods optionally further include avoiding any intermediate phase formation that has low nitrogen solubility and/or rapid solidification to prevent nitrogen loss. The form of the precursor solid is optionally micron sized powders. In another aspect, the form of the precursor solid is a thin strip having a thickness optionally of from 0.1 to 5 millimeter (mm).

Also provided are methods for manufacturing a composite article. The methods as provided herein include forming an overlying layer of nitrogen containing alloy onto a substrate by processes wherein the nitrogen containing alloy precursor material is kept substantially solid during fabrication and thus preventing dissolved nitrogen loss. The methods optionally include providing a cold spray deposition process to deposit micron sized powder precursor having dissolved nitrogen, thereby forming the overlying layer. In another aspect, the methods include a joining process forming the overlying layer, wherein both a thin strip of precursor material and the substrate are kept substantially in solid state. In yet other aspects, the methods include a casting process, wherein a thin strip precursor is kept substantially in solid state and contacting a substantially liquid metal/alloy. Upon cooling the liquid metal solidifies forming the substrate while the thin strip precursor forms the overlying layer.

The above and other objects, features and advantages of the present disclosure will become more fully understood from the detailed description given herein below and the accompanying drawings which are given by way of illustration only, and thus are not to be considered as limiting.

### BRIEF DESCRIPTION OF THE DRAWINGS

Exemplary aspects will become more fully understood from the detailed description and the accompanying drawings, wherein:

FIG. 1A is a schematic cross sectional view of a nitrided steel and the nitrogen concentration profile therein;

FIG. 1B is a schematic cross sectional view of a nitride coated article and the nitrogen concentration profile therein;

FIG. 2 is a schematic description showing the impact of nitrogen content on the toughness and corrosion resistance of austenitic stainless steel;

FIG. 3A is a schematic description of solidification process of steel involving liquid to δ-ferrite transformation, followed by austenite and the associated rejection of nitrogen gas forming pores;

FIG. 3B is a schematic description of solidification process of steel involving liquid to austenite transformation and the associated retention of dissolved nitrogen gas in the solid precursor material according to the teachings of the current disclosure (exemplary aspect);

FIG. 4 is a cross sectional view of an exemplary article having nitrogen alloy layer, contacting and overlying the substrate according to the teachings of the current disclosure;

FIG. 5 is an exemplary outline of the inventive steps for fabricating articles having nitrogen alloy layer according to exemplary teachings of the current disclosure;

FIG. 6A is a schematic arrangement of an exemplary linear friction welding process wherein the nitrogen containing alloy layer is being joined to the substrate according to the teachings of the current disclosure;

FIG. 6B is a of an exemplary the nitrogen alloy layer is embedded into the substrate by a casting process according to the teachings of the current disclosure;

FIG. 7 is the schematic arrangement for fabricating the nitrogen alloy layer on a substrate by cold spray process wherein the solid precursor powder is utilized without melting, according to the teachings of the current disclosure;

FIG. 8A is a schematic cross sectional view of an exemplary article having the nitrogen alloy protective layer wherein the nitrogen content has a step change within the layer, according to the teachings of the current disclosure;

FIG. 8B is a schematic cross sectional view of an exemplary article having the nitrogen alloy protective layer wherein the nitrogen content varies gradually within the layer, according to the teachings of the current disclosure;

FIG. 9 is a schematic view of an exemplary near netshape article being fabricated layer by layer by cold spray process deploying solid nitrogen alloy powder precursor, according to the teachings of the current disclosure;

FIG. 10 is a schematic composition map for adjusting the phase content in the solid precursor of an iron alloy having high dissolved nitrogen, according to the teachings of the current disclosure;

FIG. 11 is the cross sectional microstructure of an article having nitrogen alloy protective layer on aluminum substrate, according to some aspects of the teachings of this disclosure;

FIG. 12 presents the X-Ray diffraction patterns for as received solid precursor powder, the coating layer fabricated by cold spray process, and the layer formed by rapid solidification process, respectively;

FIG. 13 presents the Tafel plots for cast iron, aluminum and the exemplary nitrogen iron alloy, respectively;

FIG. 14 presents the wear coefficient plots for cast iron and the exemplary nitrogen iron alloys, respectively; and

FIG. 15 is the cross sectional microstructure of an article having nitrogen iron alloy protective layer on cast iron substrate, according to some teachings of the current disclosure.

### DETAILED DESCRIPTION

Various modes for carrying out the present invention are disclosed herein; however, it is to be understood that the disclosed modes are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Reference will now be made in detail to compositions, aspects and methods of the present disclosure. It is also to be understood that this disclosure is not limited to the specific aspects and methods described herein, as specific components and/or conditions may, of course, vary. Furthermore, the terminology used herein is used only for the purpose of describing particular aspects of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components unless explicitly noted otherwise.

Throughout this description, where publications are referenced, the disclosures of these publications in their entireties are hereby incorporated by reference to more fully describe the state of the art to which this disclosure pertains.

The following terms or phrases used herein have the exemplary meanings listed below in connection with at least one embodiment:

“Precursor” as used herein means the material deployed to fabricate the nitrogen containing protective layer on a substrate. In specific aspects, the solid powder or the thin strip intended for making the layer.

“Composite” as used herein means an article made up of several parts or elements. Specifically here, an object having a substrate and a protective layer intended to provide functionalities that are not otherwise provided by the individual elements alone.

“Compound” as used herein, means a material formed by reactions between elements having a stoichiometric ratio. Specifically examples include, Cr₂N, F₂N, TiN, etc.

“Solid solution” as used herein, means an alloy formed by dissolving one or more alloying element(s) in a host solid without changing its phase. In specific aspects as provided herein, γ-Fe[N], wherein N is the alloying element dissolved in FCC-Fe, the austenite phase.

The addition of nitrogen improves the strength, ductility and impact toughness in austenitic steels, while the fracture strain and fracture toughness are not affected at elevated temperatures. The strength of nitrogen alloyed austenitic steels arises from three components: strength of the matrix, grain boundary hardening, and solid solution hardening. The matrix strength is not appreciably impacted by nitrogen, rather correlates to the friction stress of the FCC (face centered cubic) lattice that is mainly controlled by the solid solution hardening of the substitutional elements like chromium and manganese. But, grain boundary hardening which occurs due to dislocation blocking at the grain boundaries, increases proportionally to the alloyed nitrogen content. The highest impact on the strength results from the interstitial solid solution of nitrogen. Nitrogen increases the concentration of free electrons promoting the covalent component of the interatomic bonding and the formation of Cr—N short range order (SRO). The occurrence of Cr—N SRO and the resultant interactions with dislocations and stacking faults are believed to play a major role in the deformation behavior of these alloys, and can be tailored to enhance the strength, ductility, and impact toughness.

The composition and temperature strongly influence the stacking fault energy (SFE) and in turn, the deformation mechanisms and strengthening behavior of austenitic steels. Increasing the SFE, causes the active deformation mechanisms to change and is generally favored to achieve pure dislocation glide and enhanced toughness. Specifically, the effect of N additions on the SFE in Cr and Mn alloyed steels is non-monotonic, exhibiting a minimum SFE at ˜0.4 wt. % N. The decrease in SFE at low N contents is believed due to the segregation of interstitial N atoms to stacking faults, however, at higher N contents the SFE increases as the bulk effect of interstitial solid solution becomes more pronounced. However, the formation of nitrides such as Cr₂N, TiN, AlN, etc. at elevated N content, affects the distribution of alloying elements within the lattice and in turn diminishes the bulk effect of interstitial solid solution and the SFE. The formation of nitrides such as Cr₂N occurs when the nitrogen content goes beyond a certain threshold value (depends on the overall composition of the alloy) and should be discouraged to take advantage of the interstitial solid solution hardening phenomenon described above.

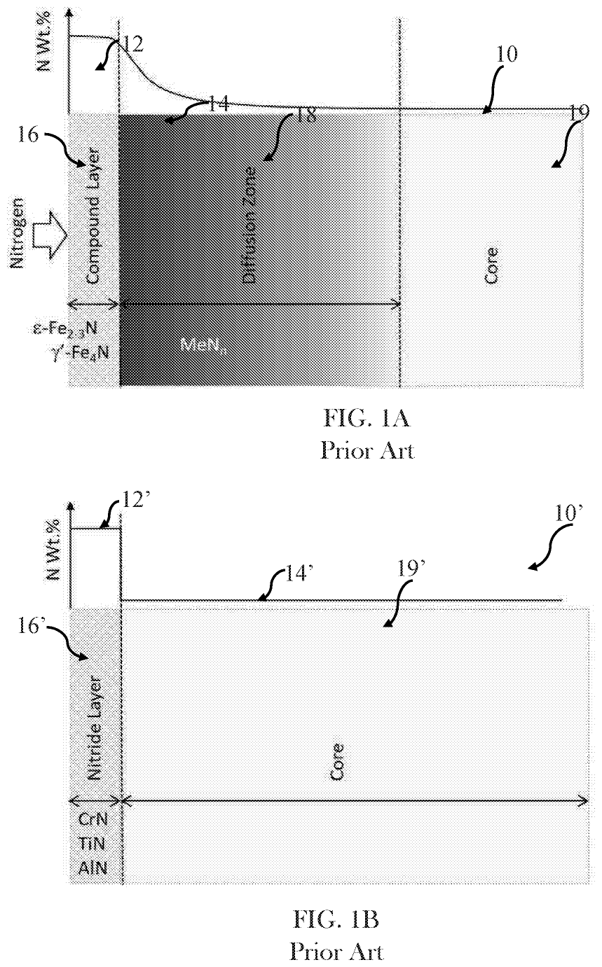

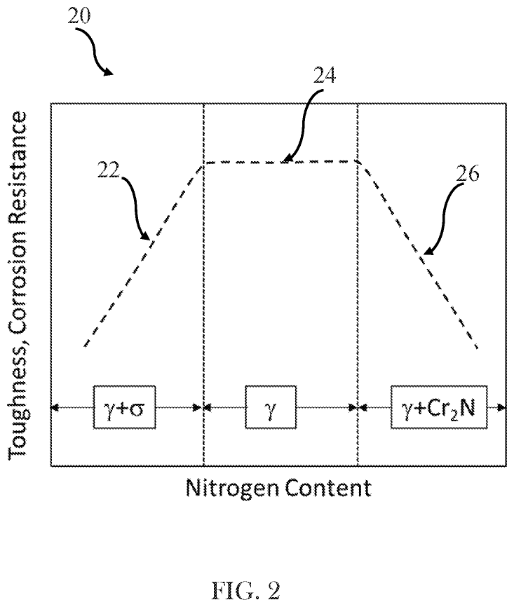

High nitrogen containing austenitic steels also exhibit excellent resistance to atmospheric corrosion. However, the corrosion resistance is also strongly influenced by the nitrogen content. At low N contents, the formation of σ phase (an intermetallic compound with Cr) at the grain boundaries as well as the formation of nitrides such as Cr₂N at high nitrogen content are detrimental to the corrosion resistance of these steels. Best corrosion resistance can be achieved if all nitrogen is in solid solution, i.e. no nitrides are precipitated. Referring to FIG. 2, it can be summarized that an optimal combination of toughness and corrosion resistance 24 can be achieved by limiting the nitrogen content within a range, wherein a substantially or completely precipitation free homogeneous microstructure with N in solid solution form can be obtained. It was found that this range of dissolved N content depends on other alloying elements present in the alloy as well as the process thermal history which will be discussed in the following sections of this disclosure. The reductions 22, 26 in toughness and corrosion resistance occur rapidly as the nitrogen content either decreases or increases from the desired range 24. As will be appreciated, the widely used industrial techniques such as nitriding or nitride PVD coatings cannot provide a protective layer with homogenous nitrogen content on a substrate, wherein the N is in the desirable solid solution state. As illustrated in FIG. 1A, during nitriding, the nitrogen content will vary considerably; at the surface forming compounds having high N to a very low level towards the core. In the case of nitride sputter coating, although the composition mostly stays uniform across the layer, but the coating is made of brittle compounds as illustrated in FIG. 1B.

One approach to obtain a homogeneous dissolved nitrogen content in a steel alloy, specifically in austenitic steel is to (i) dissolve the nitrogen into the alloy in liquid state and then (ii) solidify the alloy without losing the dissolved nitrogen during solidification. However, both the tasks have their own challenges. For example, the nitrogen solubility in liquid iron at atmospheric pressure is very low (0.045 wt. % at 1600° C.). Nitrogen in liquid alloy increases by the square root of the partial pressure (Sievert's square root law). Hence, to introduce higher nitrogen into liquid iron/steel, melting should be done using a high pressure nitrogen environment. Nitrogen alloying in the molten state may be achieved by high pressure induction or electric arc furnaces, pressure electro slag remelting furnace (PERS), and plasma arc and high-pressure melting with hot isostatic processing (HIP) etc.

Further, it is also known that the addition of certain elements such as chromium, manganese vanadium, niobium, and titanium increases the nitrogen solubility, while addition of elements such as carbon, silicon, and nickel reduces the nitrogen solubility. Hence, in order to induce high nitrogen concentrations into the melt, chromium and manganese can be added and nickel should be avoided. Furthermore, in some aspects, elements such as vanadium, niobium, and titanium, are absent or present in insignificant amounts as they are powerful nitride formers.

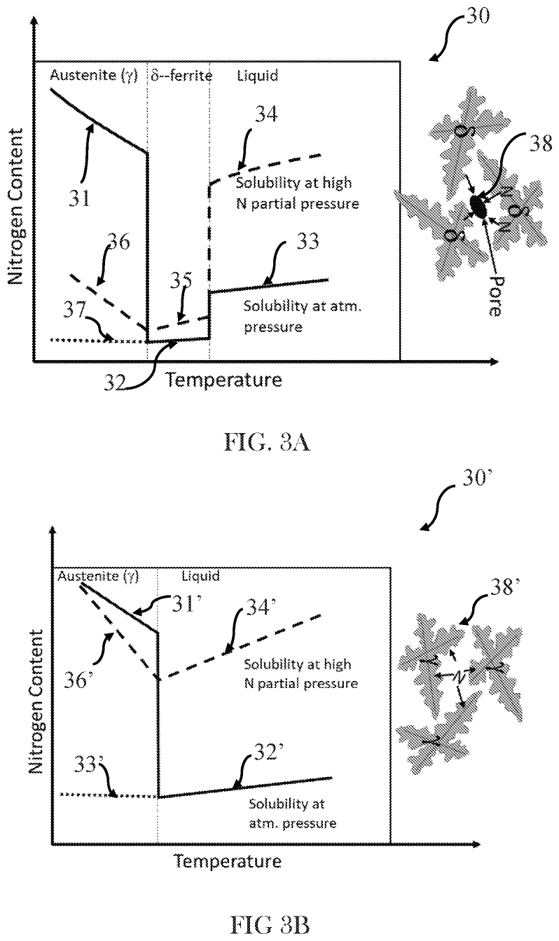

While chromium addition significantly enhances nitrogen solubility in the melt, it is also a strong δ-ferrite stabilizer. As illustrated in FIG. 3A, δ-ferrite solidification in iron alloys is associated with a wide solubility gap and a sudden drop 32 of nitrogen solubility in the material. In other words, a melt containing dissolved nitrogen 33, will lose most of its nitrogen during δ-ferrite solidification even though the subsequent lower temperature austenite phase can dissolve a much higher amount of nitrogen, 31. It is important to note that in ferritic steels, enhancing the dissolved nitrogen content 34 in the liquid by alloying additions and performing the melting operation under high nitrogen pressure, would not retain the dissolved nitrogen in the δ phase due to the associated loss during δ-ferrite solidification. This leads to the formation of interdendritic pores 38, which results in degraded material quality and the loss of nitrogen in the final material. Therefore, to retain the enhanced dissolved nitrogen achieved through high nitrogen pressure melting and alloying adjustment and transfer it to the solid austenitic material, the δ-ferrite solidification must be avoided. However, if the solidification operation is carried out under high nitrogen partial pressure, the pores can be suppressed increasing the N content to some extent 35, and importantly after the δ→θ transformation, substantial amount of nitrogen 36 can be dissolved in the γ phase; the extent of which depends on the holding temperature, pressure and time.

Now referring to FIG. 3B, in the absence of δ-ferrite solidification, wherein the liquid directly solidifies into austenitic material, much of the dissolved nitrogen 32′ in the liquid state will be retained in the mixture of austenite and the liquid 38′ and subsequently transfer into the solid austenite phase 33′. It is to be noted that the austenite phase can have a significant amount of dissolved nitrogen 31′ and in order to achieve the saturation level 31′ the liquid may contain higher dissolved nitrogen 34′ to start with, which can be achieved only by high pressure melting and alloying adjustment. Further, under high nitrogen partial pressure the austenite can pick up more nitrogen 36′ and depending upon the temperature and holding time, the nitrogen content can reach the theoretical solubility value 31′. The elimination of δ-ferrite solidification step can be achieved by carefully adjusting the composition of the alloy. To this end, manganese addition plays an important role. While enhancing the nitrogen solubility in the melt, manganese also suppresses the formation of δ-ferrite during solidification. As discussed above, the significant enhancement of strength in nitrogen alloyed austenitic steel comes from the formation of Cr—N SRO. Additionally, Cr enhances the resistance against atmospheric corrosion and hence is an important alloying addition. Further, the effect of manganese on enhancing nitrogen solubility is known to be two times less than the effect of chromium. Hence, significantly higher amount of Mn compared to Cr may be present in order to provide equivalent nitrogen solubility, eliminate δ-ferrite formation as well as achieve enhanced toughness and corrosion resistance. Another way to promote austenitic solidification and avoid degassing of nitrogen is to add carbon; however, carbon contents >0.1 wt. % have negative influence on corrosion resistance and ductility of the material and hence may be avoided.

One main problem for the production of austenitic steels containing high manganese is the strong segregation behavior of manganese that leads to heterogenic microstructure; which is detrimental to the mechanical behavior as well as corrosion resistance. Further, as discussed above, precipitation of 6 phase or nitrides such as Cr₂N should be avoided during processing to achieve high toughness and corrosion resistance. The segregation and precipitation issues can be suppressed or completely eliminated by rapidly solidifying the alloy.

In summary, the production of high nitrogen containing austenitic steels by prior methods requires a balanced control of the alloy composition and precise adjustment of the melting and solidification conditions. Due to their desirable toughness and corrosion resistance, these steels are being targeted for structural applications in transportation, energy, medical and food industry. However, their toughness and corrosion resistance can also be exploited to provide protective layers on articles as an effective solution to the problems associated with traditional nitriding and nitride coatings, which is one aspect of the teachings of this disclosure. Further, the fabrication challenges associated with the high dissolved nitrogen containing alloys especially as a protective layer on articles, need to be solved to pave the way for practical industrial applications, which is another aspect of the present disclosure.

Metallic protective layers are commonly applied by plating or additive deposition processes such as plasma spraying, laser cladding, sputtering, etc. As will be appreciated, implementing these techniques to add a protective layer exhibiting the desired characteristics, e.g., homogeneous nitrogen content in solid solution state having homogeneous microstructure with high toughness and resistance to atmospheric corrosion onto another substrate is technically very challenging and cost intensive. Metal plating in aqueous salt solution cannot provide the desired dissolved nitrogen in the deposited layer. Further, dip coating in molten metal bath to provide high dissolved nitrogen faces many challenges. The process needs to operate at high nitrogen pressure. High melting point alloys like steel can only be plated on substrates that have higher melting point than the coating alloy. High melting point alloys such as steel or titanium are typically deposited by processes (plasma spraying, laser cladding etc.) wherein the precursor feed stock is melted and then consolidated to form the protective layer. These processes are commonly practiced either in a reduced pressure environment or at atmospheric pressure. As illustrated in FIG. 3B, in order to hold the dissolved nitrogen in the molten feed stock and then transfer it to the consolidated protective layer, the processing has to be done in a high pressure nitrogen environment besides the alloying adjustment that is required to avoid nitrogen rejecting phase such as the δ-ferrite. Further, the process gases (plasma forming gas such as Ar, He, etc.) utilized in the deposition process itself have to be at much higher pressure than the deposition environment to make it operational. Yet further, to run a continuous coating operation at the required pressures, the material handling requirements quickly become very complex and expensive.

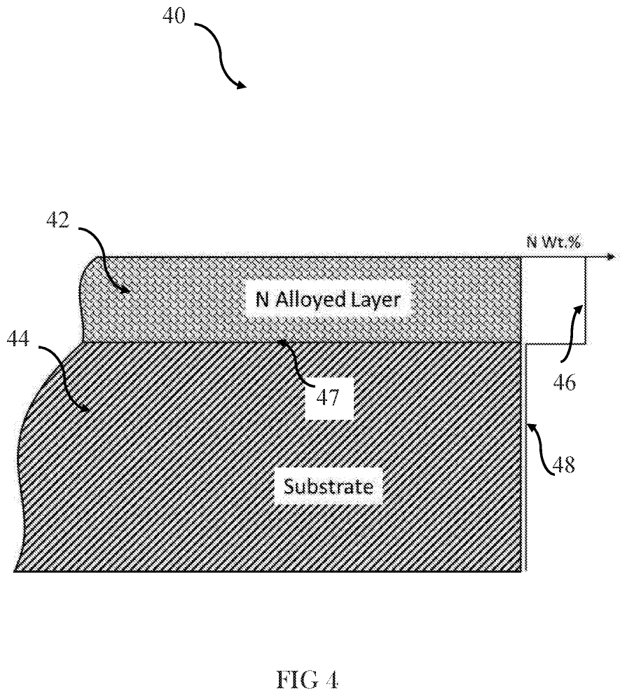

Provided is a composite article having a protective nitrogen alloy layer with a dissolved nitrogen content, the dissolved nitrogen content substantially higher than the solubility limit of N in the alloy in its liquid state at atmospheric pressure and optionally the nitrogen alloy layer being devoid of a nitride compound precipitates or nitride compound layer. A first exemplary aspect is explained hereinafter with reference to FIG. 4. Article 40 is comprised of a protective layer 42 and a substrate 44, optionally having a metallurgical bonding at the interface 47. Further, the dissolved nitrogen content 46 within the protective layer 42 is optionally uniform and is higher than the solubility limit of nitrogen in the substrate alloy 48 in its liquid state at atmospheric pressure. Optionally, the protective layer 42 is devoid of a nitride compound precipitates or nitride compound layer such as that which occurs in nitriding or nitride coating processes. Although, the desired dissolved nitrogen content will vary from one application to another, the nitrogen content may be adjusted such that undesirable precipitation formation as illustrated in FIG. 2 is avoided to improve mechanical toughness and corrosion resistance. Optionally, the nitrogen content in the alloy layer 42 is between 0.1 wt. % and 2.0 wt. %. In some aspects, the nitrogen content in the alloy layer 42 is between 0.4 wt. % and 0.9 wt. %.

A substrate 44 is optionally a surface that is flat, substantially flat, curvilinear, or other desired shape with concave, convex, or other surface configuration. The substrate may be or include a metal alloy. Illustrative examples of metal alloys include but are not limited to alloys that include Al, Si, B, Cr, Co, Cu, Ga, Au, In, Fe, Pb, Mg, Ni, C, a rare earth (e.g. La, Y, Sc or other), Na, Ti, Mo, Sr, V, W, Sn, Ur, Zn, Zr, and any combination thereof. In some aspects, a substrate includes Al or an alloy of Al. Optionally, a substrate includes Al at 80 wt % to 100 wt %. Optionally, a substrate includes a cast iron or a steel. Optionally, a substrate includes a Ti alloy.

A protective layer 42 includes a metal or metal alloy with dissolved N at a desired concentration so as to provide desired functionality in terms of toughness and corrosion resistance. A protective layer is optionally an austenite metal alloy, optionally that includes Fe as a predominant in the alloy. Optionally, a metal alloy includes N and Fe whereby the N is present at sufficient amount so as to promote an austenite structure. N is optionally present at a weight percent of 0.05 to 2 or any value or range therebetween. Optionally, N is present at a weight percent of 0.1 to 1.5, optionally 0.2 to 2, optionally 0.2 to 1.9, optionally 0.3 to 1.9, optionally 0.3 to 1.8, optionally 0.4 to 2, optionally 0.4 to 1.9, optionally 0.4 to 1.8, optionally 0.4 to 1.5. As will be further described below, the amount of N will be dependent on the desired fraction of austenite in the final material and the final composition of the material.

A protective layer 42 optionally includes Fe. Fe is optionally present at a predominant, optionally at a weight percent of 51 or greater, optionally 52 or greater, optionally 55 or greater. With Fe as a predominant an alloy is optionally a solid solution with FCC structure which is known as γ phase in the art, at the temperature at which the material is expected to be used, optionally −150° C. to 1000° C. The amount of N and other elements is optionally designed to promote the FCC structure of the metal alloy such that this structure is promoted and maintained at temperatures up to 1000° C. As such, the metal alloy is optionally substantially 100% FCC structure, optionally 99% FCC structure. Optionally, a metal alloy of a protective layer is 95% FCC structure or greater. Optionally, a metal alloy of a protective layer is 50% FCC structure or greater. Optionally, a protective layer alloy is free of other structure such as BCC.

In addition to nitrogen, a protective layer optionally includes one or more other elements that will promote FCC structure. For example, a protective layer optionally includes Mn. Mn, when present, may be provided at a weight percent of 0 to 35. Optionally, the weight percent of Mn is less than 30. Optionally, the weight percent of Mn is 19-27. Optionally, the weight percent of Mn is 20-26. The presence of N in such alloys serves to promote and stabilize a desired FCC structure even when the amount of Mn or other FCC promoting metal is less than 20 weight percent. As such, the dissolved N and Mn optionally work in concert to promote austenitic structure to the protective layer metal alloy. Optionally, the protective layer includes Ni, which also promotes austenitic structure. Ni, when present, may be provided at a weight percent of 0 to 20%. Since Ni reduces the N solubility in the protective layer, the Ni is optionally between 0 to 5 wt %. The protective layer may optionally include C, C when present, may be provided at a weight percent of 0 to 0.2%. While C improves N solubility, it also reduces the toughness of the resulting alloy. Optionally, the C is present in the alloy at 0 to 0.1 wt %.

As mentioned earlier, the strengthening mechanism in nitrogen alloy steel emerges from the formation of Cr—N SRO and hence Cr is optionally included in the provided N alloy. However, Cr is a δ-ferrite promoter as well as ferrite stabilizer. In order to control the phase of the protective layer, the ferrite stabilizing effect of Cr may be countered by adjusting the amount of N and/or Mn, both of which serve as austenite stabilizers. Further, the substrate material properties may also be taken into consideration in designing the provided alloy. For example, if the substrate is an aluminum alloy that has a FCC structure, the protective layer alloy may be 100% austenite (FCC) phase in order to match the substrate thermal coefficient of expansion. When the substrate is a ferritic cast iron or steel, a mixture of austenite and ferrite structure may optionally be chosen. In some aspects, a protective layer is 100% austenite, optionally 90% austenite or greater, optionally 80% austenite or greater, optionally 70% austenite or greater, optionally 60% austenite or greater, optionally 50% austenite or greater.

A protective layer metal alloy may include one or more other metals. Optionally, a protective alloy layer may include molybdenum. Mo, when present, may be provided at a weight percent of 0 to 5. Optionally, a protective layer metal alloy may include aluminum. When present Al may be provided at 0.01 wt % to 10 wt %. Al is optionally present at or less than 10 wt %, optionally at or less than 8 wt %, optionally at or less than 6 wt %.

As discussed above, some elements act as austenite stabilizers while others promote ferrite. Further, the extent of their influence also varies considerably. For example, N is almost 20 times more effective in stabilizing austenite compared to Mn. Similarly, Cr is almost two times more effective than Mo in stabilizing ferrite. Therefore, to predict the phases of the iron alloys of this disclosure, it is appropriate to use a nitrogen equivalent as a predictor of austenite/ferrite composition in a N alloyed protective layer as presented in this disclosure. For iron alloys primarily containing Mn, Cr, and N alloying elements, the N and Cr equivalents can be expressed as: N_eq=10 (wt. % N)+0.25 (wt. % Mn)−0.02(wt. % Mn)²+0.00035(wt. % Mn)³ and Cr_eq=wt. % Cr, respectively. Note that should any other elements be present in appreciable amount, whether austenite stabilizer or ferrite stabilizer, N_eq and Cr_eq is modified appropriately. Further, there is a lot of controversy regarding weight factors for each element and often they are empirically determined from experiments. But, there is a general agreement that N and C are the two most impactful austenite stabilizers. Since addition of C beyond 0.1 wt % is detrimental to the toughness, primarily the influence of N and Mn is considered here for exemplary illustration of alloy compositions.

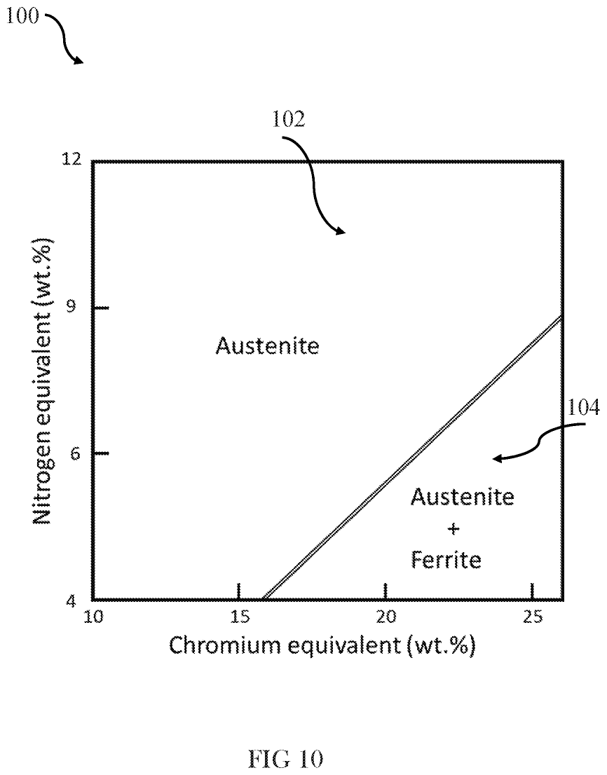

Accordingly, the alloy composition impact on phase stability is illustrated in FIG. 10, wherein the phase boundary between 100% austenite and the mixture austenite+ferrite is separated by a line which can be expressed as N equivalent=A×Cr equivalent−B. Based on experimentations, A is ˜0.98 and B is ˜11.5 for Ni free Fe—Mn—Cr—N alloy. Accordingly, exemplary alloy compositions will lead to the following outcomes as presented in Table 1. The impact of Mn content in stabilizing the austenite decreases as the content increases. For example, keeping the nitrogen concentration at 0.5 wt %, an increment of Mn content from 15 wt % to 30 wt %, decreases the N-eq from 5.27 to 3.65. Further, N concentration is the most influential factor in stabilizing the austenite. For example, by changing the N concentration from 0.5 wt % in alloy #4 to 0.7 wt % in alloy #5, results in an austenitic alloy even though significant amount of Cr (20 wt %) is present in the alloy. However, care must be taken not to increase the N content significantly beyond the stability zone especially when high amount of Cr is present to prevent Cr₂N precipitation as illustrated in FIG. 2. Alternatively, Mn addition can counter the influence of Cr and contribute towards the stability of austenite. Optionally, the N kept between 0.4 wt. % and 0.9 wt. %, Mn is kept between 19-27 wt % and the Cr is kept between 10-18 wt. %, the rest being iron.

TABLE 1

| | N | Mn | Cr | N_eq | Cr_eq | |
|---|---|---|---|---|---|---|
| Alloy # | (wt %) | (wt %) | (wt %) | (wt %) | (wt %) | Phase |
| 1 | 0.5 | 15 | 13 | 5.27 | 13 | γ |
| 2 | 0.5 | 20 | 13 | 4.6 | 13 | γ |
| 3 | 0.5 | 30 | 13 | 3.65 | 13 | γ |
| 4 | 0.5 | 20 | 20 | 4.6 | 20 | γ + α |
| 5 | 0.7 | 20 | 20 | 6.6 | 20 | γ |

An exemplary alloy containing 15 wt % Cr, 25 wt % Mn and 0.7 wt % N and the remainder Fe would form an austenite phase which is preferred in many applications, especially when the substrate is a FCC metal. In some aspects, a N alloy is or includes 13-14 wt. % Cr, 20-26 wt. % Mn, and 0.4-0.6 wt. % N with the remainder being Fe.

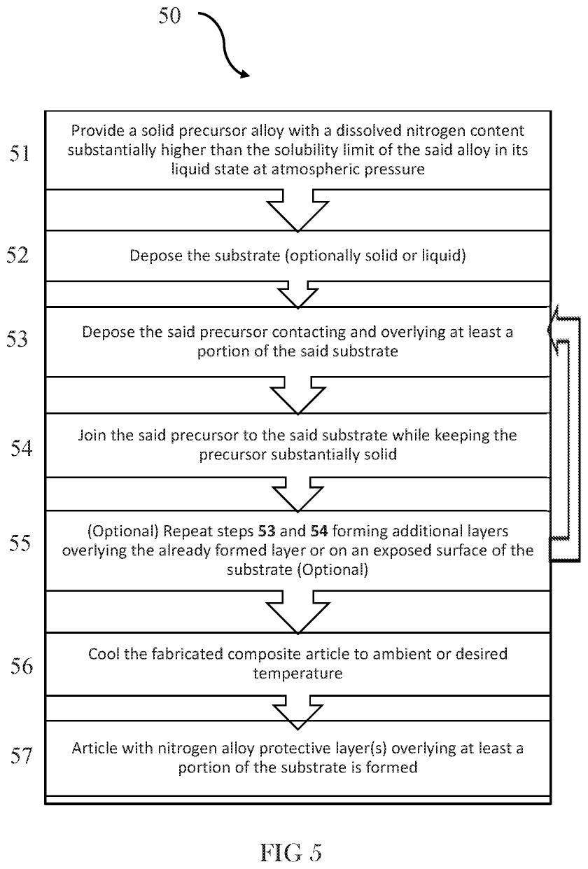

Referring to FIG. 5, exemplary methods for the fabrication of composite object 57 are provided. Method 50 may include one or more of the following steps; providing a solid precursor alloy with a dissolved nitrogen content substantially higher than the solubility limit of the alloy in its liquid state at atmospheric pressure in step 51 and disposing the solid precursor alloy on at least one substrate in step 52. The solid precursor material in step 51 can optionally be obtained by atomizing the liquid alloy containing dissolved nitrogen in the desired range and forming micron sized solid powders, directly casting into thin strip format from liquid alloy containing dissolved nitrogen in the desired range, or by a solid state dissolution method. Prior to powder atomization or strip casting, the liquid alloy composition is adjusted such that δ-ferrite formation is substantially reduced during solidification, and further the liquid alloy is prepared under a high nitrogen pressure ensuring enhanced dissolved nitrogen in the liquid. The nitrogen pressure in the melting chamber is optionally kept between 0.2 MPa and 10 MPa, optionally between 0.5 MPa and 6 MPa. The inherent rapid solidification associated with powder atomization and strip casting ensures the retention of the dissolved nitrogen in the solid precursor and microstructure homogeneity. The powder atomization may optionally be carried by compressed nitrogen gas jet, which is known as gas atomization in the art. Optionally, the powder atomization be carried out by water jet, which is known as water atomization in the art. Optionally, the powder is atomized from a liquid that is melted under normal atmosphere without containing substantial dissolved nitrogen and then processed optionally according to the teachings of U.S. Patent Application No. 62/810,680 to incorporate substantial dissolved nitrogen.

Step 52 can be achieved either manually by placing the substrate in a desired manner or via an automated system that disposes the substrate in accordance to a predetermined program. The latter approach may be used, for example, in industrial implementation. The surface quality of the precursor N alloy plays an important role in the joining process of step 54, if used. The surface preparation of the substrate is less important. As a way of illustration, two types of bonding can occur between the substrate and the protective layer. In the case of nitriding, wherein the protective layer grows on the substrate through a diffusion process, the bonding is generally termed as “metallurgical” in the art. Similarly, fusion joining as is achieved in this disclosure also establishes a metallurgical bonding. On the other hand, deposition processes such as plasma spraying establish a mechanical adhesion, wherein extensive surface preparation such as grit blasting or surface grooving is necessary for good adhesion. In general, the metallurgical bonding used by the present processes is preferred and exhibits superior thermomechanical and corrosion properties especially under cyclic loading, and is preferred in step 54 of method 50. Various joining methods to achieve metallurgical bonding will be illustrated below in this disclosure. While a clean and grease free surface is preferred, no special surface treatment is necessary.

In step 53, a strip precursor is optionally deposed onto the substrate of step 52, followed by step 54, wherein the said precursor is joined to the substrate and during the joining process, the strip precursor remains substantially solid ensuring the retention of the dissolved nitrogen in the protective layer. The joining process is optionally a linear friction welding process, wherein the interfacial layer softens into a plastic state due to oscillating linear motion between the precursor and the substrate and upon cooling forms a metallurgically bonded joint. Optionally the strip precursor comprises of preformed anchors and is deposed onto a molten alloy, the latter upon solidification forms the substrate. The embedment of the anchors into the solid substrate ensures the adhesion to the substrate. The molten alloy temperature is preferably below the melting point of the precursor alloy so that the precursor doesn't appreciably melt and lose its dissolved nitrogen, although surface interaction may promote metallurgical bonding. Exemplary illustrations of strip joining process is provided below in this disclosure.

Optionally, step 53 and step 54 are conducted simultaneously, wherein the solid powder precursor is deposed onto the substrate at high velocity which upon impact forms a metallurgical bonding with the substrate and thus forms the alloy layer. This can be suitably achieved by a supersonic nozzle, wherein the solid powder precursor is injected into a high velocity gas jet which accelerates the powders. The gas is optionally heated to increase the precursor powder temperature, but keep it below the melting point. Additional energy may optionally be provided onto the powder or both the substrate and the powder in steps 53 and 54. However, the precursor and the layer formed from it optionally remain substantially below the melting point. An exemplary energy source is optionally a laser, an electron beam, a plasma or infrared source, while a laser beam may be used in some aspects due to the flexibility and simplicity afforded by it. The deposition nozzle moves according to CAD data or tool path generated by a control system to build the nitrogen alloy protective layer over the substrate. Optionally, the nozzle movement can be done manually.

Method 50, according to some aspects, may further include a logic gate to determine the need for additional layers in step 55. If an additional layer is required, steps 53-54 are repeated. When the powder precursor is used, only thin layers (micrometers) may be built in one pass and hence the process is repeated multiple times to build an appreciable thickness of the protective alloy layer. If the desired layer thickness has been fabricated, the composite object is cooled to ambient temperature in step 56 and method 50 concludes in step 57 and the object is removed. The steps in method 50 are not necessarily always discrete. In some aspects, there are one or more overlaps between one or more discrete steps leading to a continuous fabrication process. Further, some steps may be omitted.

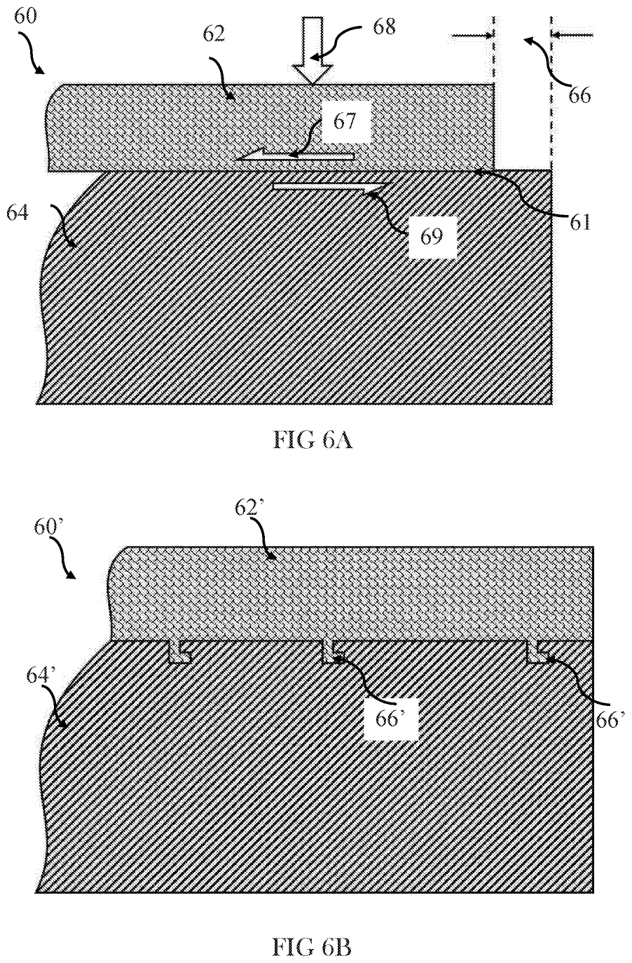

An exemplary fabrication method 60 operating according to the teachings of the present disclosure is illustrated in FIG. 6A. The method 60 comprises of a precursor strip 62 deposed onto the substrate 64. While making intimate contact along the interface 61 between the substrate and the strip, the strip is subject to a mechanical load 68 and oscillating movement with an amplitude of 66 to generate friction and heat along the interface. Optionally, the substrate 64 is kept stationary and the strip 62 makes the oscillating movement to generate friction, although both the substrate and the strip oscillating movement 67, 69 may be used. The mechanical friction and heat along the interface makes a thin plastic zone. Much of this plasticized material is removed from the weld as flash, because of the combined action of the applied force and part movement. Surface-oxides and other impurities are removed, along with the plasticized material, and this allows metal-to-metal contact between parts and allows a metallurgic joint to form. The process is generally known as friction welding in the art and many variants of the process exist in the art. Optionally, the motion between the substrate and the strip can be rotary depending upon the geometry. The beneficial effect of this joining process, especially for the nitrogen alloy precursor, is that it takes place in the solid state and involves no melting of the parts to be joined, and thus ensures the retention of the dissolved nitrogen in the protective alloy layer. The precursor strip thickness is optionally between 0.5 mm and 10 mm, optionally between 0.5 mm and 2 mm. Further, the strip may be optionally cut into a size that can either cover a portion of the substrate surface or entirely cover the surface of the substrates. To obtain a good joint, a specific power input should be exceeded. The frequency, amplitude and pressure have an effect on this parameter, which was defined as:

$$w = \frac{∝ fP}{2 π A} ,$$

with α being the amplitude, f the frequency, P the pressure and A the interface area. From this relationship it can be seen that the power input can be increased by increasing the frequency, amplitude or pressure. For example, to join the nitrogen alloy strip with 40×25 mm area onto aluminum substrate, optionally the parameters can be; frequency: 30 Hz-60 Hz, amplitude: ±2 to ±3 mm, pressure: 80-150 MPa and time: 7-25 s.

Although method 60 can effectively fabricate the article with the nitrogen alloy protective layer, in this method both the N alloy strip and the substrate may be substantially flat such that intimate contact can be made along the interface. Further, for a large article the mechanical force required to make friction welding across a large area quickly goes up and becomes difficult to control. Obviously this limits the shape and size of the articles that can be fabricated. As such, an alternative manufacturing method 60′ for an article is illustrated in FIG. 6B. Method 60′ includes use of a solid nitrogen alloy precursor 62′ having anchors 66′ deposed adjacent to a liquid or semi-solid metal/alloy substrate 64′ such that the anchors are immersed in the fluid. Optionally, the fluid metal/alloy's melting point is lower than that of the nitrogen alloy layer such that the precursor solid doesn't melt. Upon solidification the fluid forms the substrate and the precursor becomes the protective layer. For example, the precursor solid is a nitrogen alloy steel and the substrate is an aluminum alloy. Thus both wear and corrosion resistance of an aluminum article can be enhanced. Optionally the article is a brake rotor which is lightweight due to use of an aluminum substrate and has the necessary braking surface that is the nitrogen alloy protective layer as provided herein. The contact time between the solid precursor and the substrate fluid may be minimized to prevent any detrimental reaction and intermetallic formation between the precursor and the substrate alloy. Optionally, the fluid substrate metal is supplied from the bottom so that it comes in contact with the solid precursor at the end, and upon contact immediately solidifies minimizing the interfacial reaction. Optionally, the fluid metal is supplied by an electromagnetic pump from the bottom of the casting assembly having the precursor solid deposed at the top of the mold cavity. Optionally, the substrate alloy is a semi-solid, but behaving like a fluid due to heavy shear action during the feeding process. Thus, the overall temperature of the fluid is at a few hundred degrees C. below the melting point, but can be filled into the cavity easily. This further limits the surface interaction between the precursor and the substrate fluid. The casting process is generally known as thixocasting in the art.

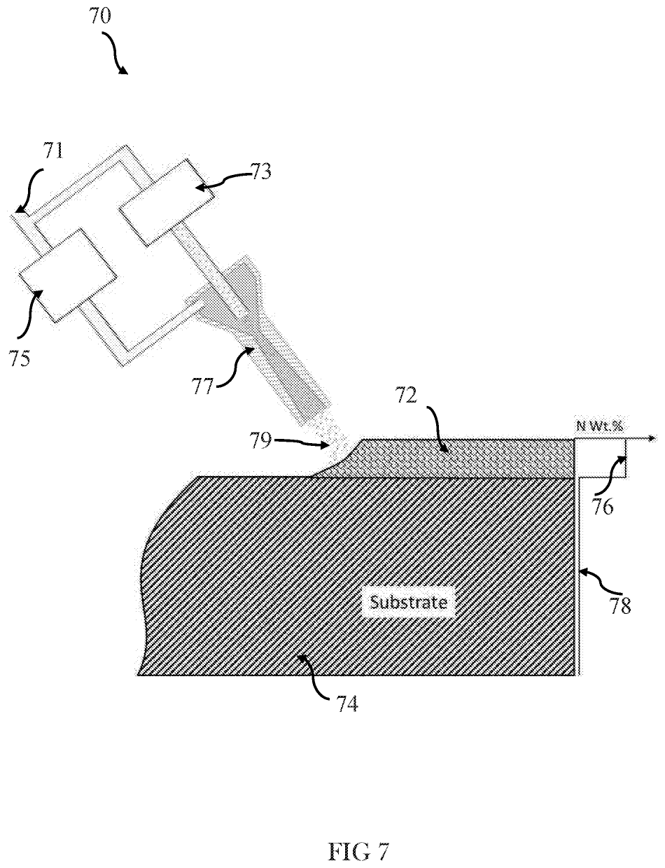

Referring to FIG. 7, a manufacturing method 70 operating according to the teachings of the present disclosure is illustrated. The manufacturing method 70 includes us of a cold spray nozzle 77 operably connected to a gas heater 75 and a powder feeder 73. A gas inlet 71 supplies gas to the gas heater 75 at high pressure, which is generally known as process gas in the art. Further, gas is also supplied to the powder feeder which is generally known as carrier gas in the art. The process gas pressure is optionally same as the carrier gas pressure, however, they may operate at different pressures. The process gas pressure optionally is 100 pounds per square inch (PSI), 200 PSI, 300 PSI, 400 PSI, 500 PSI, 600 PSI, 700 PSI, 800 PSI, or higher. The process gas pressure is optionally 100 PSI to 800 PSI, or any value or range therebetween. The process gas is heated by the gas heater 75 prior to entering into the convergent and divergent nozzle 77, wherein the gas attains very high velocity in the divergent section. There are many known variants of the nozzle geometry in the art. The process gas temperature is optionally 50° C., 100° C., 200° C., 300° C., 400° C., 500° C., 600° C., 700° C., 800° C., 900° C. or higher. The process gas temperature is optionally from 50° C. to 900° C., or any value or range therebetween. The nitrogen alloy precursor powder is supplied by the powder feeder 73 and is carried by the carrier gas and is delivered to the process gas stream. The precursor powder can optionally be delivered in the convergent section of the nozzle or the divergent section of the nozzle, although feeding in the divergent section is preferred. U.S. Pat. No. 9,481,933 teaches the benefits such arrangement. The delivery of the precursor powder in the convergent section will require high carrier gas pressure compared to the delivery in the divergent section. Accordingly, the carrier gas pressure optionally is 100 PSI, 200 PSI, 300 PSI, 400 PSI, 500 PSI, 600 PSI, 700 PSI, 800 PSI, or greater. The carrier gas pressure is optionally 100 PSI to 800 PSI, or any value or range therebetween. The precursor solid powder having the dissolved nitrogen, absorbs heat from the process gas as well as accelerates towards the substrate due to drag force exerted by the process gas. Unlike conventional plasma spraying, the bonding occurs through a process termed as “adiabatic shear instability” that leads to a metallurgical bonding. The powder particle must attain a required velocity to form a metallurgical bond with substrate, which is known as the critical velocity in the art. The critical velocity depends on the precursor powder properties, size, temperature as well as the properties of the substrate and substrate temperature. The process parameters are adjusted accordingly to provide critical velocity to maximum number of the particles in the particle stream 79. For example, a nitrogen alloy powder having 0.7 wt. % N, 19 wt. % Mn, 15 wt. % Cr and rest iron with powder size ranging from 20-45 μm requires a critical velocity in excess of 500 m/s at 500° C. particle temperature to successfully form a consolidated alloy layer. The precursor powder size is optionally between 5 and 250 microns, is optionally between 5 and 150 microns, optionally between 10 and 75 microns. The particle stream 79 is directed onto the substrate 74 and upon impact and bonding, a protective layer 72 is consolidated. The powder temperature as well as the target temperature remains substantially below the melting point of the alloy thereby retaining the alloyed nitrogen in the protective layer. Thus, the coating layer fabrication can be carried in open atmosphere without requiring a high pressure nitrogen environment. Further, the spray nozzle 77 is optionally operably connected to a robot that can traverse the nozzle according to a preprogrammed path. Further, the protective layer 72 can be built layer by layer until the required thickness is achieved. Depending upon the application, the thickness of the layer is optionally 5 microns, 10 microns, 100 microns, 1000 microns, or greater. The ancillary componentry such as the power supply, control systems, auxiliary heating source and gas tanks are not shown and their inclusion in the system is understood. The manufacturing system 70 can be configured in a variety of ways. For example, a CNC motion system can be utilized instead of a robot. Further, another robot can be deployed to manipulate the substrate. The entire system can be enclosed in a controlled environmental chamber.

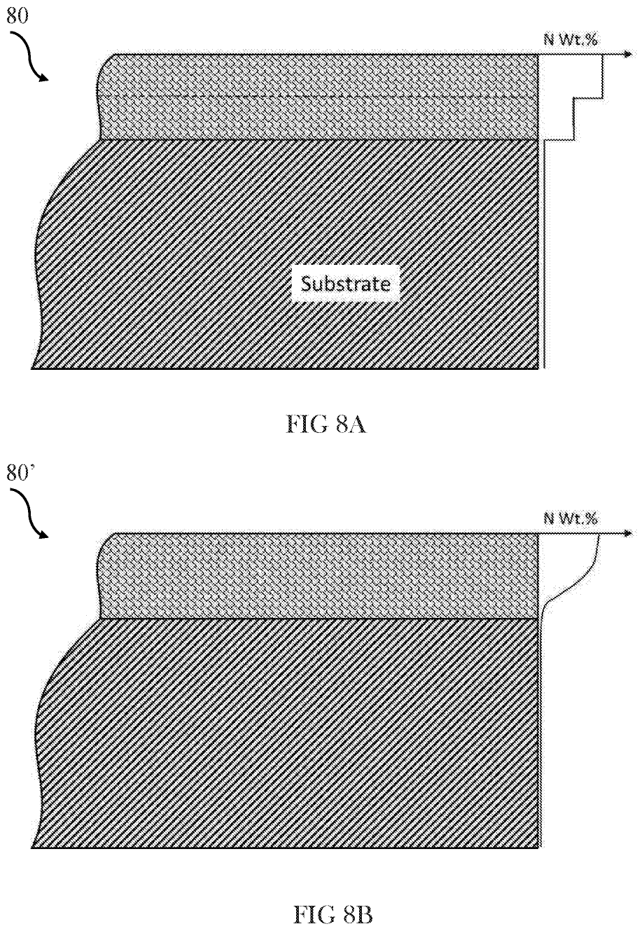

Method 70 can fabricate the nitrogen alloy layer in various forms. As illustrated in FIG. 7, the nitrogen content across the entire layer can optionally be uniform. Alternatively, as illustrated in FIG. 8A, article 80 comprised of a protective layer that has two different nitrogen contents along the thickness. This can be achieved by utilizing two different powder precursor with different nitrogen content. Yet further, the nitrogen content can be progressively varied along the thickness as illustrated in FIG. 8B by deploying several powders with progressively varying nitrogen content.

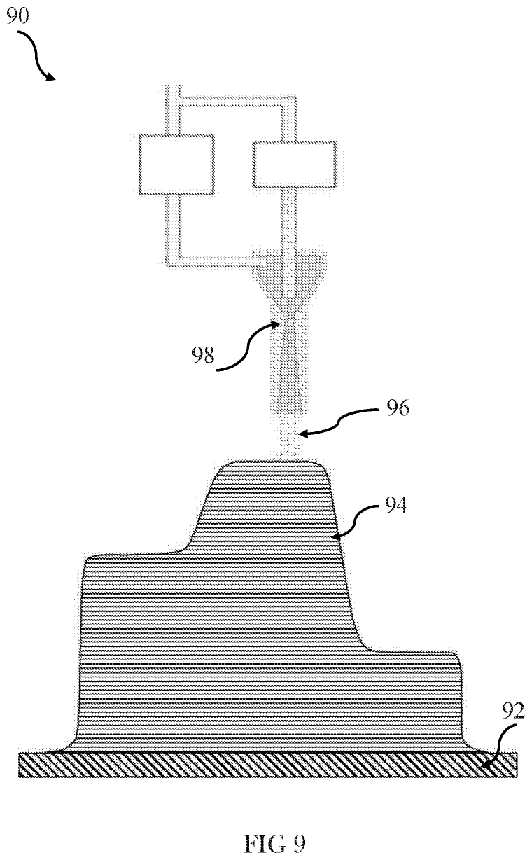

Referring to FIG. 9, an exemplary manufacturing method 90 operating according to the teachings of the present disclosure is deployed to 3D print metal parts having high dissolved nitrogen. As will be appreciated, most metal 3D printers melt the precursor powder during layer by layer deposition. However, these processes aren't suitable for making netshape objects having high dissolved nitrogen, unless the process is carried out under high pressure nitrogen environment. The challenges associated with such operational conditions are discussed earlier. Accordingly, the teachings of this disclosure, where in the nitrogen alloy precursor is not melted during consolidation, enables the retention nitrogen in the final part, even though the processing is done at atmospheric pressures.

Various aspects of the present disclosure are illustrated by the following non-limiting examples. The examples are for illustrative purposes and are not a limitation on any practice of the present invention. It will be understood that variations and modifications can be made without departing from the spirit and scope of the invention.

### EXAMPLE

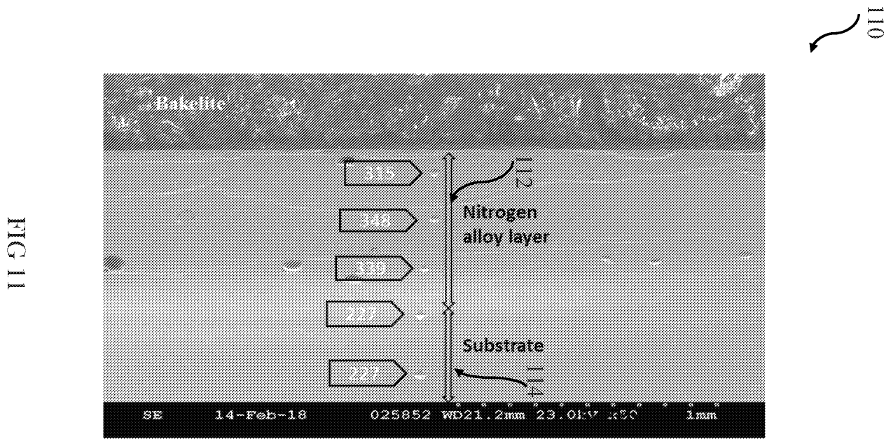

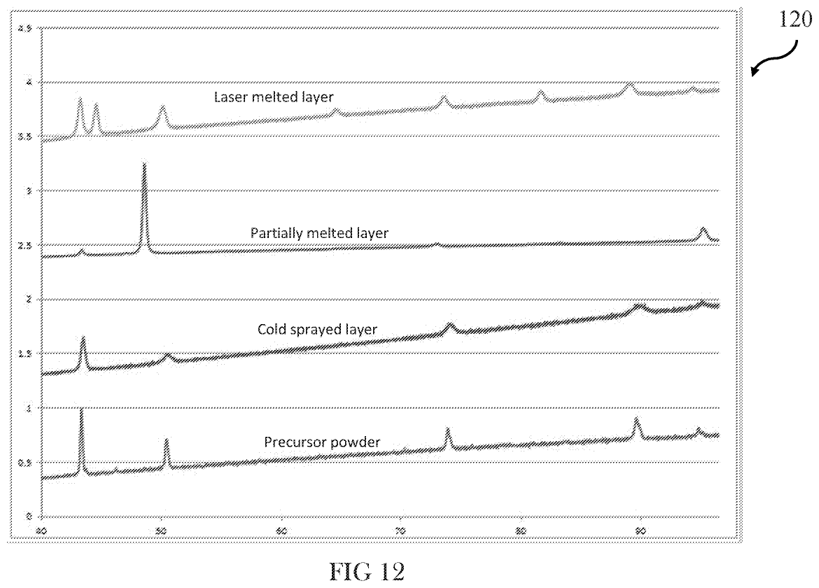

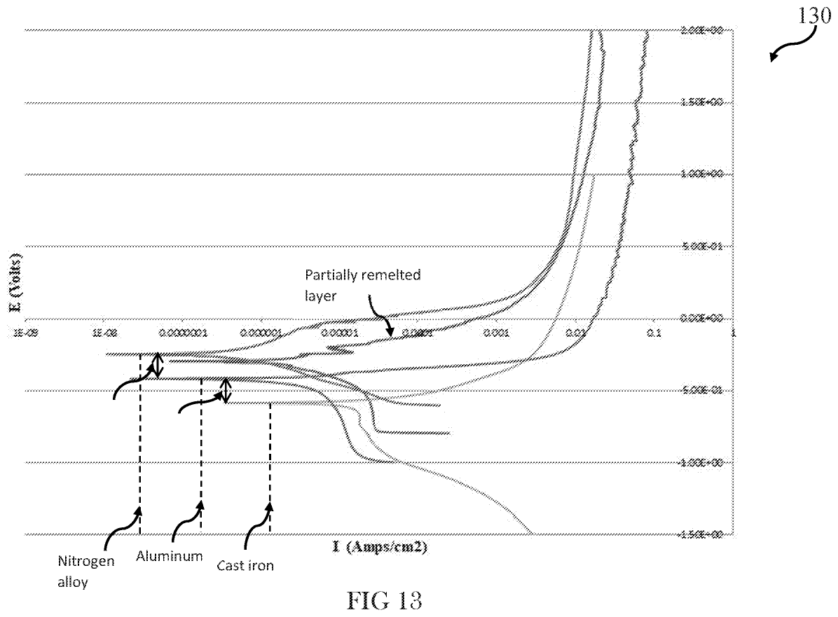

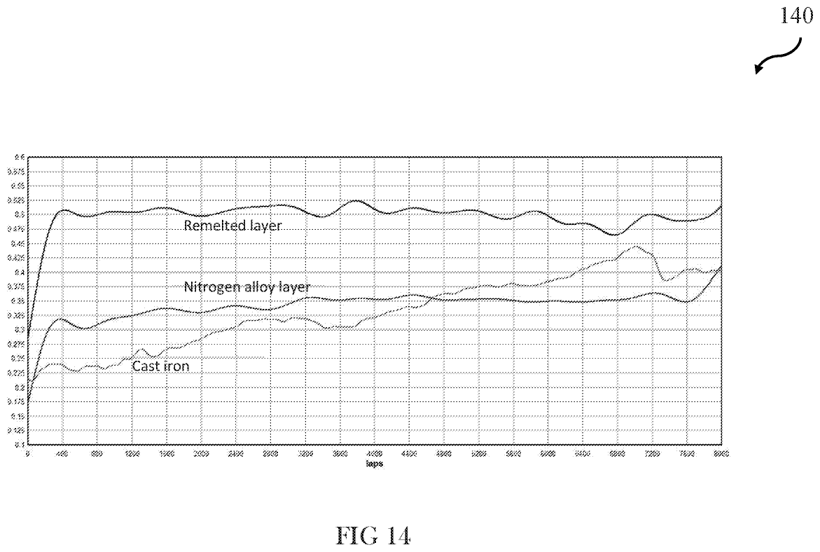

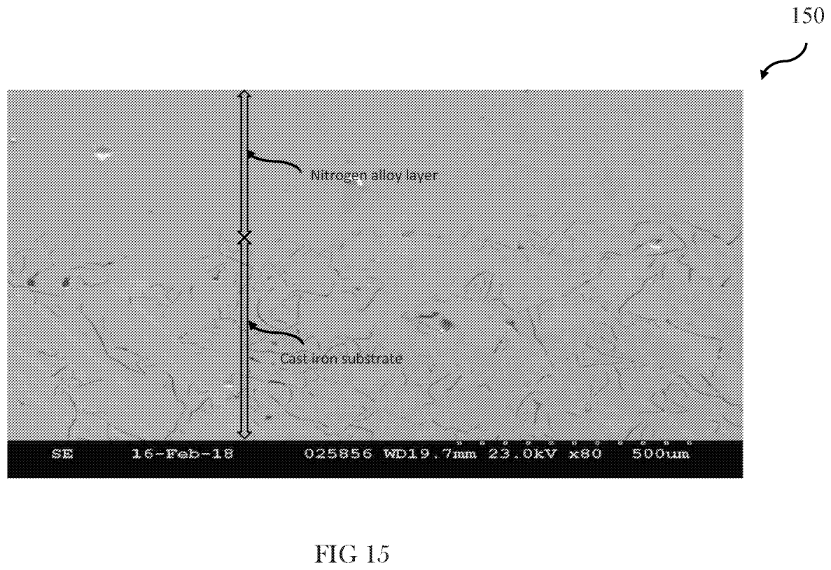

Alloy layers were fabricated by a cold spray process described in U.S. Pat. No. 9,481,933. The precursor powder utilized in these experiments had 0.7 wt. % N, 19 wt. % Mn, 15 wt. % Cr and rest iron with powder size ranging from 20-45 μm and was processed according to the teachings of U.S. Patent Application No. 62/810,680. Both steel and cast iron substrates were utilized. For cold spray, the process gas was nitrogen at 500 psi and 600° C. and the target distance was 10 mm. The powder was fed at 10 g/min rate. The layer microstructure is shown in FIG. 11. As seen the layer possesses uniform hardness across which is substantially higher than the substrate. Such hardness profile is not feasible in nitriding process. FIG. 12 shows the XRD profile of different materials. As can be seen the austenite phase of the precursor powder is maintained in the cold sprayed material. Partial remelting (<20%) of the layer by a laser beam shifted the phases whereas complete remelting caused ferritic structure. As described earlier, remelting possibly lost the dissolved nitrogen as the process was carried out under normal atmospheric pressure. The corrosion behavior of the alloy layer is compared in FIG. 13. As seen the nitrogen alloy layer has excellent corrosion resistance (low current) compared to cast iron and aluminum, which somewhat reduce with partial remelting. The wear characteristics of the N alloy protective layer is compared in FIG. 14. As seen the nitrogen alloy layer shows steady wear characteristics compared to cast iron. Upon remelting, the wear coefficient of the alloy layer increased. FIG. 15 shows the cross section microstructure of the alloy layer on a cast iron substrate.

### REFERENCE LIST

U.S. Pat. No. 7,160,635
U.S. Pat. No. 6,623,846
U.S. Pat. No. 7,294,077
U.S. Pat. No. 8,920,881
U.S. Pat. No. 9,481,933
US Application Publication No: 2014/0096736
US Application Publication No: 2015/0118516
US Application Publication No: 2017/0167031

### NON-PATENT REFERENCES

Mittemeijer, E. J. (2013), Fundamentals of Nitriding and Nitrocarburizing, ASM Handbook, Volume 4A, Steel Heat Treating Fundamentals and Processes, J. Dossett and G. E. Totten, editors.
V. V. Berezovskaya, et al, TWIP-EFFECT IN NICKEL-FREE HIGH-NITROGEN AUSTENITIC Cr—Mn STEELS, Metal Science and Heat Treatment, Vol. 57, Nos. 11-12, March, 2016.
E. Yu. Kolpishon, et al., Possibilities of Reducing the Chromium and Manganese Contents in a Nitrogen-Bearing Austenitic Steel, Russian Metallurgy (Metally), Vol. 2007, No. 8, pp. 728-732

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof.

1. A three dimensional article comprising:
a high nitrogen content solid solution material, the solid solution material in the form of a powder prior to assembly into the article;
the high nitrogen content solid solution comprising an alloy formed of a solid solution of one or more metals and nitrogen, the nitrogen present in a concentration in the alloy higher than a solubility limit of nitrogen in the alloy in a liquid state at atmospheric pressure
wherein the alloy is optionally substantially free of nitride compound precipitates.

2. The article of claim 1 wherein the alloy is free of nitride compound precipitates.

3. The article of claim 1 wherein the alloy comprises:
Fe as a predominant;
Mn, the Mn present at up to 35 weight percent;
Ni at up to 20 wt %;
C at up to 0.2 wt %, or
combinations thereof.

4. The article of claim 1 wherein nitrogen is present in the alloy at 0.05 weight percent to 2.0 weight percent.

5-7. (canceled)

8. The article of claim 1 wherein the alloy comprises an austenite metal alloy.

9. The article of claim 1 wherein the alloy has an FCC structure, the FCC structure defining 50% or greater the structure of the alloy.

10. (canceled)

11. The article claim 1 wherein the alloy is free of BCC structure.

12. An article comprising:
a substrate comprising a surface; and
a protective layer on at least a portion of the surface, the protective layer comprising an alloy having a solid solution of one or more metals and nitrogen, the nitrogen present at a concentration higher than a solubility limit of nitrogen in the alloy in a liquid state at atmospheric pressure.

13. The article of claim 12 wherein the interface is a metallurgical bond between the substrate and the protective layer.

14. The article of claim 12 wherein the protective layer is free of nitride compound precipitates.

15. The article of claim 12 wherein the concentration of nitrogen in the protective layer is uniform, or wherein the concentration of nitrogen in the protective layer varies as a gradient through a thickness of the protective layer.

16-21. (canceled)

22. The article of any one of claims 12-16 wherein the substrate comprises Al, a metal alloy, or an alloy of two or more elements of Al, Si, B, Cr, Co, Cu, Ga, Au, In, Fe, Pb, Mg, Ni, C, a rare earth (e.g. La, Y, Sc or other), Na, Ti, Mo, Sr, V, W, Sn, Ur, Zn, Zr, and any combination thereof.

23-32. (canceled)

33. The article of any one of claims 12-16 wherein the protective layer has an FCC structure, the FCC structure defining 50% or greater the structure of the protective layer.

34-35. (canceled)

36. The article of any one of claims 12-16 wherein the protective layer comprises one or more anchors, the one or more anchors penetrating a surface of the substrate.

37. A method of producing an article comprising:
providing a solid protective layer material, the solid protective layer material comprising an high nitrogen content alloy formed of a solid solution of one or more metals and nitrogen, the nitrogen present in a concentration in the alloy higher than a solubility limit of nitrogen in the alloy in a liquid state at atmospheric pressure,
contacting the solid protective layer material with a surface of a substrate, and
forming a metallurgic bond between the solid protective layer and the substrate at the surface while maintaining the protective layer material substantially solid.

38. The method of claim 37 wherein the solid protective layer material is in the form of a powder, or wherein the solid protective layer material is in the form of a strip, the strip optionally substantially flat.

39. (canceled)

40. The method of claim 37 wherein the metallurgic bond is formed by fiction welding, or
wherein the substrate, the protective material or both are oscillated to form the metallurgic bond.

41. (canceled)

42. The method of claim 37 wherein neither the protective layer material nor the substrate are transitioned to a liquid during the forming.

43. The method of claim 37 wherein the precursor material is contacted to the substrate surface by ejection from a nozzle and the bonding occurs by adiabatic shear instability.

44. The method of claim 37 wherein the substrate is in the form of a fluid or semi-solid when contacting the solid protective layer material, wherein the melting temperature of the protective layer material is greater than the temperature of the substrate.

45-66. (canceled)
